(19) United States
(12) Patent Application Publication
(10) Pub. No.: US 2013/0020256 A1
(43) Pub. Date: Jan. 24, 2013

(54) Method for improving wastewater treatment in structures containing concentrated populations of individuals

(71) Applicants: John Williams, Riverwoods, IL (US); Richard Schici, Lombard, IL (US); Bulbul Ahmed, Aurora, IL (US)

(72) Inventors: John Williams, Riverwoods, IL (US); Richard Schici, Lombard, IL (US); Bulbul Ahmed, Aurora, IL (US)

(21) Appl. No.: 13/552,450

(22) Filed: Jul. 18, 2012

Related U.S. Application Data
(60) Provisional application No. 61/508,741, filed on Jul. 18, 2011.

(51) Int. Cl. C02F 3/00

(52) U.S. Cl. 210/614; 210/601

(57) ABSTRACT

The instant invention describes a method of treating wastewater generated from structures containing concentrated numbers of individuals prior to the wastewater entering a municipality's sewer system. The method involves delivering bacterial formulation to an area that has access to the main pipes responsible for delivering the structure's wastewater to the municipality's sewer system whereby such bacteria establish a biofilm which treats the wastewater generated by the occupants of the structure as the wastewater is transported to the city's main sewer system.

### REFERENCE TO RELATED APPLICATION

This application claims the benefit of the filing date of U.S. Provisional Patent Application No. 61/508,741, filed on Jul. 18, 2011, the contents of which are incorporated herein by reference in its entirety.

### FIELD OF THE INVENTION

This invention relates to methods of wastewater treatment; and more particularly, to methods of reducing the loading of municipal wastewater treatment plants by treating wastewater generated from structures containing concentrated populations of individuals prior to entry into a city's sewer system and wastewater treatment plants.

### BACKGROUND OF THE INVENTION

Urbanization, or the process in which increasing populations reside in cities and suburbs of the cities, continues to be the trend in the U.S. Cities, which have traditionally been the source of economic opportunity, and the center for education, the arts, and other forms of entertainment, continue to show increase in population. The projected rise in energy costs, particularly petroleum-based fuels, ensures that urbanization will continue. Super cities, such as New York or Chicago, tend to contain large numbers of individuals in concentrated areas. According to data from the 2010 census, the City of New York has a population density of 10,630 people per Km² and the city of Chicago has a population density of 4,447 people per Km². High population density is not unique to cities within the United States. International cities having a high density population include Seoul, South Korea (17,288/Km²), Tokyo, Japan (14,400/Km²), and Mumbai, India (20,624/Km²).

One of the main challenges of any city, whether large or small, is the removal of and treatment of wastewater. The treatment of wastewater in less dense municipal areas is similar to the treatment of high density municipal areas. Domestic wastewater contains waterborne residues of the activities of daily life, washing, cleaning, cooking, and sanitary wastes. Treatment must be designed to remove substances that can or should not be discharged to the environment or would be unacceptable in reclaimed wastewater to be reused. The principle waste components requiring attention in treatment include: 1) large floating materials such as paper, sticks, or food remnants; 2) small floating particles with oils and grease that are lighter than water; 3) settlable solids which are typically removed in an primary settling process; 4) dissolved and colloidal organic material that is decomposed by a biological treatment process; 5) a second settling process to remove the biomass that grows in the biological treatment process and is needed for recirculation to make the treatment process work efficiently; and 6) live microorganism, including human pathogens that may be of public health significance. The treated effluent is typically disinfected prior to discharge. The rate at which normal human activity produces wastewater is not uniform through a 24 hour daily cycle. In fact it is much less at night requiring treatment tank volumes to be designed to even out flows to permit treatment processes to perform with consistent effectiveness.

In the early 20th century, cities began to adopt the biological methods that now form the basis by which wastewater treatment plants function. Microorganisms (mainly bacteria) act to catalyze the oxidation of biodegradable organics and other contaminants generating innocuous by-products such as carbon dioxide, water and biomass (sludge). In these systems, bacteria grow and divide, producing biosolids and clean water effluent. Today, this metabolism occurs in wastewater treatment plants, which have the limits of size, retention time, processing capacity, and of course municipal budgets. Numerous improvements to wastewater once delivered to a municipal treatment plants have been developed, including U.S. Pat. No. 7,569,148 which describes a process of wastewater treatment utilizing sequencing batch reactor with a membrane filtration system. U.S. Pat. No. 6,660,163 describes a process of treating wastewater introduction of biological during the main waste treatment process or for solid minimization purposes during post-treatment processes. U.S. Pat. No. 7,550,076 describes an improvement to systems for treating wastewater which utilizes aeration. The '076 patent describes an aeration nozzle which is designed to allow particle sized wastewater to pass through.

Technology exists, such as that described in U.S. Pat. Nos. 5,578,211 and 5,788,841 and commercialized by In-Pipe Technology Company, Inc. (Wheaton, Ill.) to effectively enhance the fundamental wastewater treatment process by starting treatment at strategic locations throughout the sewer collection system. Miles of sewer pipe are transferred into an active part of the wastewater treatment process, optimizing the entire infrastructure. This improves operating economics without additional capital expenditure. Since it uses natural, biological methods that work with the treatment plant's own processes, such technology is an environmentally and economically sound sustainable solution.

While all municipalities, whether larger or small, struggle to treat wastewater in an economical and efficient manner and benefit from the above mentioned technology, large cities with large human densities face problems not encountered by their less densely populated counterparts. These large, densely populated cities contain the highest concentrations of populations and are under intense scrutiny from governmental agencies, such as the EPA, to improve the effluent to meet higher standards. While many cities are receptive to improving the effluent, costs, aging infrastructure, and growing populations make it difficult to develop a perfect strategy. Since most large cities contain high human densities, individuals tend to live and work in structures that house highly concentrated numbers of individuals. These point source contributors can significantly contribute to overloading the city's main sewer systems, resulting in negatively affecting the outfall of clean water to lakes, rivers, or streams.

Therefore, a method of treating wastewater coming from the point source contributors which reduces loading to the wastewater treatment plant head works is needed.

### SUMMARY OF THE INVENTION

The instant invention describes a method of treating wastewater generated from structures housing concentrated numbers of individuals prior to the wastewater entering a municipality's sewer system. The method involves delivering a bacterial formulation, having one or more bacteria species and/or subspecies' to an area within the structure that has access to the main pipes responsible for delivering the structure's wastewater to the municipality's sewer system. Such structures may include, but are not limited to, sky scrapers, high rise residential buildings, high rise commercial buildings, or stadiums or arenas.

Most modern sewers are large biological reactors where bacteria can grow and respire using organics, nutrients, and electron acceptors from the wastewater. In the collection system, bacteria act to catalyze the oxidation of biodegradable organics and other contaminants generating by-products such as carbon dioxide, water, and biomass. Bacteria grow and divide producing biosolids (sludge) and clean water. This metabolism occurs in wastewater treatment plants around the world. However, the limits of size, retention time, processing capacity, and operating budgets create economic challenges for every municipality.

In an effort to utilize the miles of existing pipe and convert the passive sewer system into a meaningful treatment step, methods have been developed (U.S. Pat. Nos. 5,578,211 and 5,788,841 and commercialized by In-Pipe Technology Company, Inc. (Wheaton, Ill.)) to utilize the collection system as an active part of the wastewater treatment process. The technology improves the economics of wastewater treatment using bio-augmentation methodology. A formulation of high concentrations of select, facultative, nonpathogenic natural soil bacteria is introduced at strategic locations throughout the sewer collection system in accordance with an engineered plan. Continual addition to the outer reaches of the wastewater collection system allows for microbial growth throughout the surface of the sewer pipes, thereby modifying the sewer biofilm. By taking advantage of the residence time of the wastewater within the sewer, this technology improves the ability of the sewer biofilm to degrade the readily biodegradable soluble organic material, and to convert slowly biodegradable particulate organic material to readily biodegradable soluble organic material. By extending wastewater treatment from the plant into the sewer collection system, the technology enhances the microbial community such that more reactions occur in the sewer biofilm that contribute to increased metabolism of wastewater compounds within the sewer, and reduces the influent wastewater loads to the wastewater treatment plant. In addition, the wastewater treatment plant receives more available readily biodegradable soluble organic material.

While the above mentioned system has been highly effective, successful creation of a bio-augmentation system can be contributed to the fact that generators of wastewater, i.e. households or businesses, are not highly concentrated and are separated by distance. For cities that contain structures having concentrated populations, the amount of wastewater generated can be heavy, resulting in the production of large amounts of wastewater in smaller areas. In order to overcome the possibility of overwhelming the sewer system and causing increased loading at the wastewater treatment plant head works, the method in accordance with the instant invention is used to create a pre-treatment step prior to entry within the sewer system.

Using the structure's piping systems as a pre-treatment step improves the wastewater treatment plant efficiency. The bacteria in the formulation work with or without oxygen inside the structures system, converting organic materials and nutrients into carbon dioxide and nitrogen gas. Each pound of organic material and nitrogen removed in the structures system prior to delivery to the sewer system transit, without energy input, is a pound that does not require treatment in the wastewater treatment plant. Biodegradable organic material can be in the form of slowly biodegradable particulate or in the form of readily biodegradable soluble, and organic material conversion can be one or two distinct operations, namely metabolism of the readily biodegradable soluble material, or conversion of slowly biodegradable particulate organic material into a readily biodegradable soluble format and the actual metabolism of the soluble material. The bio-augmentation could further provide a mechanism to remove fats, oils, or grease (FOG) from the building's piping system since the bacteria formulation are enzyme factories which secrete full spectrum of enzymes including lipase and esterage required for the hydrolysis FOG.

The process as described herein results in 1) reducing wastewater loads, i.e. how much of one or more components such as suspended solids concentrations, BOD concentrations, ammonia concentrations, nitrogen concentration, are contained in the flow, 2) reduction or elimination of FOG accumulation in the municipal sewer lines, and 3) reduction in odors by outcompeting sulfite reducing activities. In addition, by creating such a system within the piping of the buildings, costs associated with wastewater treatment could be partially transferred to the users, i.e. the building, as part of its maintenance costs. By moving the services from the street manholes to service areas within the building, reduced traffic blockage, a common problem with servicing current city sewer systems is avoided. In addition, servicing above ground in the mechanical rooms of the structure reduces other field serving issues, such as adverse weather related service issues in collection systems. Furthermore, the collection systems are receiving similar biological treatment as collection system bio-augmentation before entering the wastewater treatment plant.

In an illustrative example, the present invention includes a method of treating wastewater generated within a structure containing a high concentration of individuals therein prior to the internally generated wastewater entering into an externally located wastewater treatment system comprising one or more of the following steps: 1) identifying at least one structure containing a large population of individuals or occupants therein, the structure being fluidly connected to a external wastewater site, such as a municipal wastewater treatment plant, and associated delivery structures, such as the sewer pipes that deliver the wastewater to the plant, with one, or having at least one wastewater flow channel feeding wastewater generated within the structure to an external wastewater treatment site or associated delivery structures; 2) determining if the structure is eligible as a high population concentration structure for treating wastewater generated therein prior to placing the wastewater into the external wastewater treatment site or associated delivery structures; and 3) exposing the at least one wastewater flow channel to a solution which forms a wastewater pretreatment prior to placing the structure's wastewater into the external wastewater treatment site or associated delivery structures, whereby pre-treating the wastewater generated within the structure reduces wastewater loads being delivered to the wastewater treatment site. The pretreatment may include the step of exposing the at least one wastewater flow channel to a bacterial population, the bacterial population including one or more species and/or subspecies of bacteria and may include releasing the wastewater into an external wastewater site and associated delivery structures, with one or more species and/or subspecies of bacteria therein. The bacterial populations may be placed into the system intermittingly or continuously. The present process also includes exposing all wastewater channels, such as for example piping that transports wastewater within and out of the structure, within the structure to bacterial populations. Release of bacteria populated within the wastewater as well as bacteria populated within the piping systems of the building improves many wastewater treatment plant processes, such as membrane or media processes. For buildings that use water reclaiming processes, the present method would also provide benefit to those processes by providing for better water reuse.

The method in accordance with the present invention may additionally include one or more of the following steps: A) monitoring the wastewater exiting the structure; B) analyzing the wastewater exiting the structure for one or more components, characteristics, or combinations; C) adjusting the exposure of at least one wastewater flow channel to the wastewater pretreatment based upon the analysis; and/or E) providing at least one sensor adapted to detect one or more components, characteristics, or combinations thereof of the exiting wastewater; F) providing a biological dispensing unit at or near at least one wastewater flow channel; G) electrically coupling a sensor to the biological dispensing unit; and H) dispensing said biological population from said biological dispensing unit based on the results of the analysis of said exiting wastewater. Exposure of the bacterial populations may be correlated to one or more factors, such as water usage periods, wastewater production periods, or combinations thereof, based on daily, daily, monthly, yearly or seasonal needs as well as the type of wastewater generated. The present invention may also include the step of releasing the wastewater generated within the structure having one or more predetermined bacterial populations therein to the wastewater treatment site or its associated wastewater system delivery structures.

In an alternative embodiment, the present invention may include a method of reducing the loading of a primary wastewater treatment site system by treating wastewater generated from a predetermined area having one or more highly populated structures within the area prior to entry into the primary wastewater treatment site or its associated wastewater system delivery structures comprising the steps of: 1) identifying an area having a predetermined number of structures having a concentration of occupants therein, 2) identifying each structure from the area having a predetermined number of structures having a concentration of occupants therein which is fluidly connected to a municipal wastewater treatment system; 3) identifying within each of the structures an access to at least one wastewater flow channel fluidly connected to the municipal wastewater treatment system; 4) distributing to at least one wastewater flow channel from each of the structures a bacteria population, the bacteria population being at a concentration sufficient to establish a population of bacteria within at least one wastewater flow channel, within the wastewater generated within each of the structures and released to the municipal wastewater treatment system, or combinations thereof, thereby forming a pretreatment; and 5) exposing the wastewater generated from each of the structures to the pretreatment prior to placing each of the structure's wastewater into the municipal wastewater treatment system, whereby distribution of the microbial population to the at least one flow channel from each of the structure reduces wastewater loads prior to entry into said municipal wastewater treatment system.

Accordingly, it is an objective of the instant invention to provide a method of treating wastewater within structures containing concentrated populations of individuals.

It is a further objective of the instant invention to provide a method of treating wastewater within structures containing concentrated populations of individuals which is designed to dispense one or more bacterial formulations to the structure's wastewater piping system.

It is yet another objective of the instant invention to provide a method of treating wastewater within structures containing concentrated populations of individuals which is designed to dispense one or more bacterial formulations to the piping system of the structure at different times, depending on pre-determined load volumes at given time periods.

It is a still further objective of the instant invention to provide a method of treating wastewater within structures containing concentrated populations of individuals which is designed to reduce FOG and other piping blockage due to normal usage.

It is a further objective of the instant invention to provide a method of treating wastewater within structures containing concentrated populations of individuals which is designed to establish beneficial biofilms within the structure's piping, thereby providing piping protection and surface area for wastewater treatment.

It is yet another objective of the instant invention to provide a method of treating wastewater within structures containing concentrated populations of individuals which provides for continual reinforcing of the bacteria in order to out-compete the non-beneficial fecal sulfate reducing bacteria (SRB's)

It is a still further objective of the invention to provide a method of treating wastewater within structures containing concentrated populations of individuals which reduces solution sulfide in the treatment process, thereby reducing the release of corrosive hydrogen sulfide and mitigating the collection system infrastructure corrosion.

It is a further objective of the instant invention to provide a method of treating wastewater within structures containing concentrated populations of individuals which provides for adjustment of one or more bacterial formulations based on industrial, difficult waste, or extremely high volume waste applications.

It is yet another objective of the instant invention to provide a method of treating wastewater within structures containing concentrated populations of individuals which utilizes one or more bacterial formulations that can grow either by respiration using oxygen/nitrate or nitrite (aerobic/anoxic condition) as terminal electron acceptors or by fermentation in the absence of electron acceptors (anaerobic condition), which at low or no dissolved oxygen concentrations, can grow and multiple efficiently in other pathways which can reduce energy requirement downstream at the wastewater treatment plant by 30-600.

It is yet another objective of the instant invention to provide a method of treating wastewater within structures containing concentrated populations of individuals which increases operating efficiencies by reducing influent organic loading and the costs associated with sludge handling and disposal, expensive chemicals, energy usage, and FOG.

It is a still further objective of the invention to provide a method of treating wastewater in structures containing concentrated populations of individuals which reduces H₂S odor and corrosion, extending and protecting the life of the existing infrastructure by converting the structure's collection system into an active, beneficial part of the wastewater treatment process.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a schematic illustration of the interconnection of structures containing concentrated populations and a municipal water system;

FIG. 2A is a block diagram of an illustrative embodiment of a dosing unit used to deliver a bacterial formulation to the wastewater piping system of structures containing concentrated populations;

FIG. 2B is a block diagram of the dosing unit shown in FIG. 2A electrically coupled to sensors;

FIG. 3 is a graphical representation illustrating microbial load variance over time, based on incoming wastewater load;

FIG. 4 is a flow chart outlining an illustrative example of the method in accordance with the instant invention.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

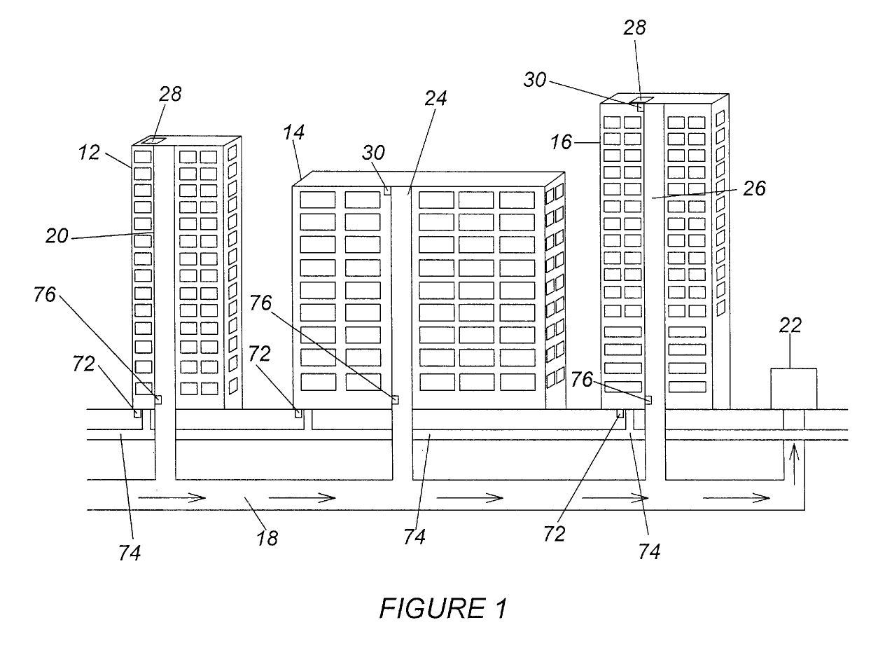

Referring to FIG. 1, a partial schematic representation of a city showing several structures containing concentrated populations is shown. Structures 12, 14, and 16 represent common types of structures seen in a city which contain concentrated populations. For example, structure 12 represents a high rise condominium which houses multiple families and single-person residences. Modern condominiums, particularly in super cities, are designed to be a “neighborhood” within the city and are built to be somewhat self-sustaining. It is not uncommon for these building to contain 20-30+ stories, with 8-12+ units per floor. In addition to the high number of occupants, these buildings typically house other businesses, such as restaurants, cleaners, or convenience stores, bringing in numerous non-occupants into the building on a daily basis. Structure 14 represents a hotel. Typical hotels in large urban settings are multi-levels, capable of housing and/or receiving a large number of individuals. Referring to Structure 16, a typical high-rise commercial building is illustrated. Most commercial buildings of this nature contain one or more independently owned businesses, housing highly concentrated numbers of individuals. While structures 12, 14, and 16 illustrate typical structures that contain large populations of individuals, other structures, such as large theaters, stadiums, and universities, can benefit from the method in accordance with the instant invention.

While structures 12, 14, and 16 may vary with respect to the actual size and number of individuals, each of such structures contain highly concentrated numbers of individuals that produce wastewater. With the average daily use of water estimated 80-100 gallons per day per individual, these structures are responsible for generating large volumes of wastewater in small areas. All of these structures contain linkage to a city's sewer system. For example, high rise condominium 12 is fluidly connected to the main city sewer pipes through piping system 20. For ease of illustration, the piping system 20 is shown as a single pipe running the entire vertical length of the building. However, the system can be more complex than that, and include multiple interconnecting pipes. Piping system 20 is designed to remove all wastewater generated from the individual occupants or users of the building. All wastewater generated, therefore, eventually gets transferred to the main city sewer system 18, and moved to the city's waste water treatment plant 22 which is located downstream of the condominium 12.

The hotel 14 and the high rise commercial building 16 are set up in a similar manner. Wastewater generated by occupants and visitors of each of the buildings are transported to the city's main sewer system through piping system 24 of the hotel 14 and the piping system 26 of the high-rise commercial building 16. Ultimately, the wastewater that has been transferred to the city sewer system 18 will be processed at waste water treatment plant 22 as well.

One of the problems unique to cities that contain multiple structures having concentrated numbers of occupants is that the wastewater generated contributes to increased loading of the city's main waste water treatment plant. The difficulty urban municipalities such as New York or Chicago have is that buildings which house concentrated populations generate large amounts of wastewater in concentrated areas. In contrast, suburban municipalities tend to contain structures housing smaller populations of individuals and which tend to be spread out over longer distances and thereby may not suffer the same problems of wastewater loading on their wastewater treatment systems.

The method in accordance with the instant invention attempts to address such problems and is designed to create a model in which bio-augmentation is incorporated into the high-rise structures through the wastewater pipes. Such process has several important outcomes. Of major importance to expanding cities is the need to reduce wastewater loads to the municipality's wastewater treatment plant head works. Referring back to FIG. 1, delivery of a bacterial formulation designed to reduce such loads is delivered to one or more specific point contributors, such as the high-rise residential building 12, the hotel 14, or high-rise commercial building 16. In a preferred embodiment, such bacterial formulation is delivered through a roof-top based delivery system 28, an internally-based dosing system 30, or combinations thereof. In either case, the delivery system is ideally placed at the highest location of the building that contains access to the drainage or wastewater removal system of the building, including but not limited to mechanical rooms or janitor's closets. The delivery system can be designed to deliver the bacterial formulation based on gravity or through injection using isolation valves. In any manner, by injecting the bacterial formulation at the highest point, the entire piping systems 20, 24, or 26, acts as part of the overall municipal wastewater treatment systems as each piping system is seeded with the bacteria to begin the bio-augmentation process prior to reaching the main sewer system 18. On a pre-determined basis or as needed, the piping system is continuously dosed with the same, or modified, bacterial formulation.

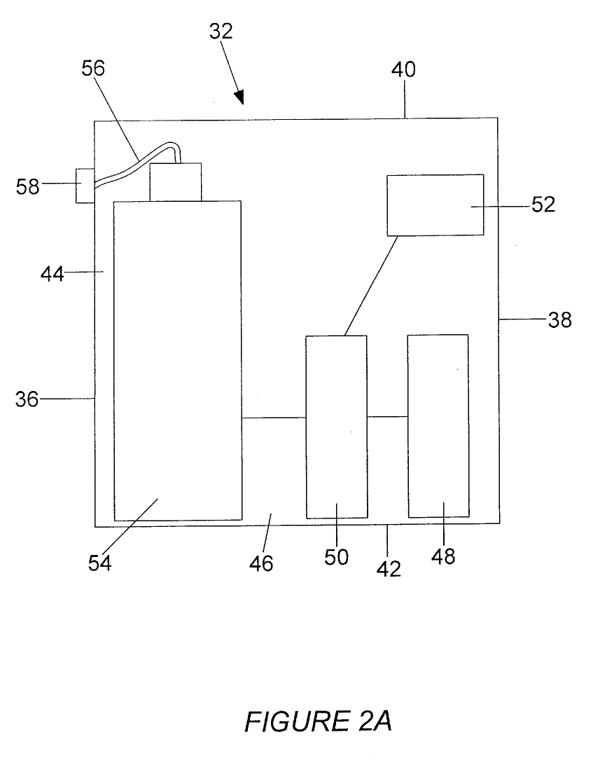

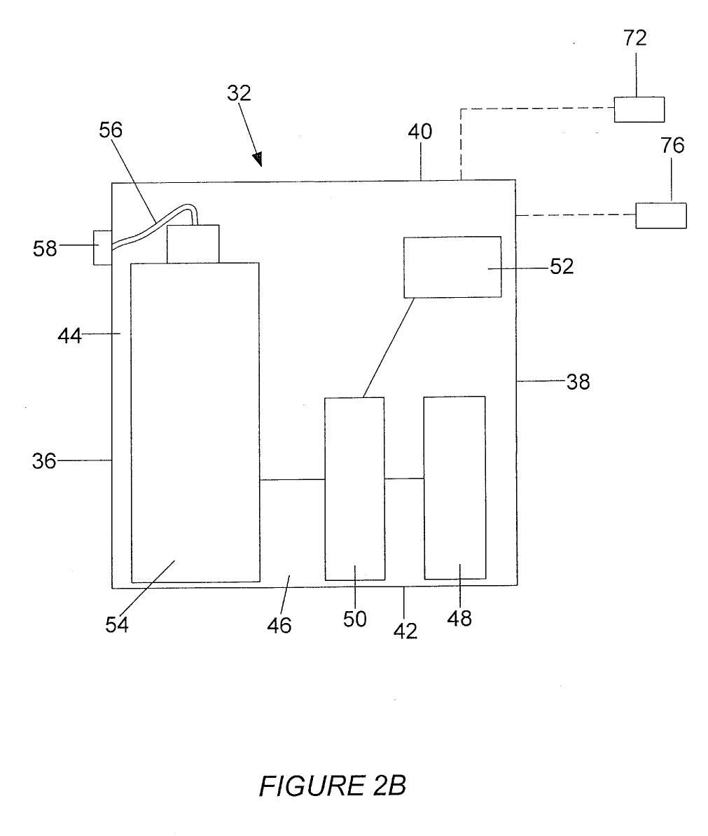

Referring to FIG. 2A, an illustrative embodiment of a delivery unit is shown. As described previously, the delivery system is preferably placed somewhere along the highest point of the building which has direct access to the wastewater pipes. The delivery unit 32 contains a panel containing side walls 36 and 38 arranged in parallel fashion, and walls 40 and 42 arranged in parallel fashion. The delivery unit 32 also contains a back wall 44 and a front wall, not illustrated in order to show the internal components of the delivery unit 32. Walls 36, 38, 40, 42, 44 and the front wall interconnect to form an enclosed interior portion 46. The interior portion 46 contains the working elements of the delivery unit 32. The delivery system is powered by a power source, illustrated herein as a battery pack 48. A pump 50, illustrated herein as a solenoid pulse pump, is operated by a small circuit board 52. A nozzle (not illustrated) may be used to help dispense the bacterial formulation in a directed manner. The delivery system holds a source of the bacterial formulation which is stored in a reservoir 54 and dispensed through tubing 56 to the outside of through opening 58. In order to repopulate the piping system, the delivery unit 32 can be configured to continually deliver a pre-determined amount of the bacterial formulation over a period time.

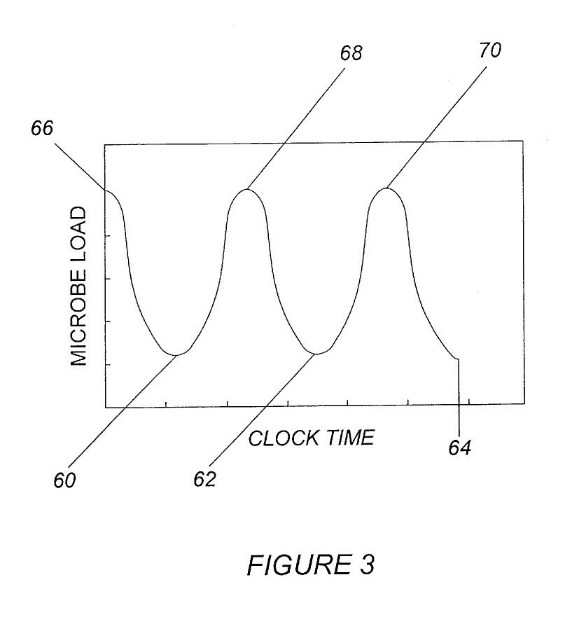

In a preferred method, the delivery unit 32 is adapted to operate on diurnal cycles, having circuitry and a time clock to deliver various amounts of the bacterial formulation based on pre-determined factors, such as historical loads. Referring to FIG. 3, points 60, 62, and 64 correspond to times in a 24 hour cycle in which wastewater generation is at its lowest. Accordingly, the amount or concentration of bacterial formulation injected into the system will be low. In contrast, points 66, 68, and 70 correspond to the highest wastewater generating periods. During these times, bacterial formulation can be injected into the systems at its highest level. For periods in between, the amount of bacterial formulation allowed into the system can be adjusted accordingly. Delivery of the bacterial formulation can also be based on month or seasonal cycles. Delivery of bacterial formulation volume can be based on per capita basis for each building with the minimum established by the city based on population, seasonal temperatures, odor control, and fats/oil/grease control requirements. Additionally, the delivery unit 32 can be adjusted to deliver bacterial formulation loads based on other factors, such as shifting occupancy, i.e. for hotels, holiday schedules, or events which may bring larger than normal occupants to the structures.

Most buildings contain sensors 72, see FIG. 1, which measure the amount of clean, usable water delivered to the building through the city's clean water piping system 74. Accordingly, the delivery unit 32 can be programmed, through the use of a receiver/transmitter (not illustrated) adapted for receiving wired or wireless signals, to receive data and/or instructions from the sensors about the amount of water the building is taking in. Based on the idea that the amount of water taken into the building is a prediction of the amount of water that wastewater generated, should the amount of water coming into the building reach or surpass a pre-determined level, the delivery unit will be “instructed” to increase delivery of bacterial formulation to the system.

Alternatively, or in addition to, the present invention may utilize sensors 76 and/or sensor analyzers (not illustrated) which measure and/or analyze the characteristics and components of the wastewater generated by the structure prior to emptying into the pipes of the city sewer system 18. Such monitoring allows for correlating the amount of bacteria placed into the system to be modified, i.e., increased, decreases, or terminated, based on the analysis of the structure's wastewater. In one embodiment, the sensors 72 and 76 may be electrically coupled 77 via wiring or wirelessly to the dispensing unit 32, see FIG. 2B.

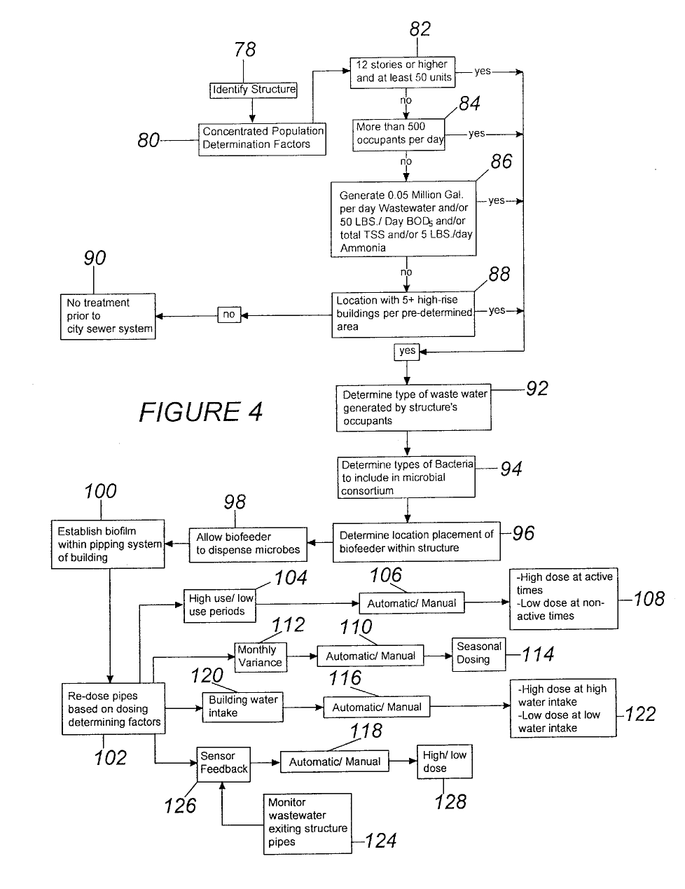

In order to minimize overloading a municipality's wastewater treatment plant, it is vital that the right structures be identified as containing concentrated populations of individuals, see 78 and 80 on FIG. 4 flowchart. If the building is not identified as such, then no wastewater within the structure will be treated with a bacterial formulation prior to the wastewater entering the city sewer system, see 90. Illustrative determination factors which may be useful in determining if a structure contains concentrated populations of individuals include, but are not limited to, 1) if a building has a pre-determined number of stories, such as 12 stories or higher, and a predetermined number of units, such as 50, and/or 2) if the structure contains a pre-determined number of occupants in a specific time frame (at least 500 occupants per hour, per day), and/or 3) do the occupants of the structure generate a pre-determined amount of wastewater per individual or in total, or other wastewater markers known in the art (suspended solids levels, biochemical oxygen demand concentrations, ammonia concentrations, nitrogen concentrations), for example does the structure generate 0.05 million gallons per day wastewater and/or 50 lbs/day biochemical oxygen demand (BOD₅) and/or total suspended solids (TSS) and/or 5 lbs/day ammonia, and/or 4) is the structure in an area with a minimum number of other high occupancy structures, see 82-88.

Once a structure is determined to contain a concentrated number of individuals, the amount and types of bacteria to be included in the bacterial formulation is determined based on the nature of the wastewater that is generated by the structure's occupants, see 92 and 94. The bacterial formulation is then placed within the structure's piping system with the use of a biofeeder, such as described previously, see 96. As the bacterial formulation is placed within the piping system, see 98, a biofilm will be established, see 100 having properties which aids in breaking down the wastewater as it travels through the piping system. To maintain the biofilm that has been established with the desired bacteria population, the pipes must be re-populated by addition, or re-dosing of the bacterial formulation.

Re-dosing can be accomplished by identifying various determining dosing factors, see 102. For example, for some structures, periods in a day in which the occupants generate high/low amounts of wastewater will determine microbial loading or delivery, see 104. In such a case, dosing manual or automatic, see 106, is tied to those time periods. For periods of high activity, such as between the hours of 7:00 AM and 9:30 AM, and periods between 11:30 AM and 2:00 PM, high loads of bacterial formulation are dosed into the system. For periods of low activity, such as between the hours of 9:31 AM and 11:29 AM, and periods between 2:01 PM and 5:00 PM, low loads will be placed in the system see 108. Dosing, manual or automatic see 110, can also be based on monthly, 112, or seasonal usage, see 114. Alternatively, dosing, manual or automatic see 116 or 118, can be performed based on pre-determined measurable factors. For example, the amount of water a building intakes within a pre-determined time can be monitored, see 120. Should the amount deviate from a set point, bacterial dosages inserted into the system can be increased or decreased accordingly, see 122. Alternatively, the wastewater leaving the building's piping system can be monitored, see 124, using a sensor feedback, see 126, which, for example maybe be a system in which the sensor is electrically coupled, via wires or wireless, to a dispensing unit for delivering various dosages, such as high or low dosages, see 128. Factors such as, but not limited to odor, organic materials levels, or FOG levels can be used to determine if an increase or decrease in microbial delivery is warranted.

The method of treating wastewater generated from structures housing concentrated numbers of individuals prior to the wastewater entering a municipality's sewer system results in using the wastewater collecting system of the building as an active part of the treatment process. The bacteria selected as part of the bacterial formulation can be any combination of bacteria that increases the efficiency of the wastewater treatment plant and extends the life of existing infrastructure. The method according to the instant invention repopulates the structure's piping, the wastewater, and the sewer biofilm with bacteria that excrete the full spectrum of enzymes to rapidly degrade complex organic substrates to bio-available substrates. The bacteria used therein are more flexible in their oxygen requirements, and are better adapted to the wastewater environment than the intestinal bacteria that are introduced continually through normal wastewater collection activities. The continuous addition of bacterial formulation allows a gradual repopulation of the building's biofilm by bacteria that are more efficient at biological nutrient removal than the bacteria that are present in untreated conditions. As the bacteria grow, multiply, and reach the wastewater treatment facility, they are assisting in further degradation of the remaining organic materials in all phases of treatment process.

The system, in accordance with the instant invention provides a method for delivery of the bacterial formulation as a part of the buildings normal maintenance scheme and will greatly reduce FOG issues and other blockages due to normal usage. Large amounts of FOG coming from the building are deposited into waste steams on a continuous basis and tend to congeal at the entrance and within the piping system, creating flow problems and odors due to the property of poor solubility. Continuous injection or cyclic injection will improve the piping system of the structures, reducing the FOG blockage and waste will immediately be in contact with the bacterial formulation as it contacts the surface area of the coded pipes. It is estimated that the bio-augmentation using bacterial formulation in accordance with the instant invention will improve the wastewater quality transferred to the wastewater treatment plant by increasing, by approximately 40%, readily biodegrable soluble organic material.

The bacterial formulation is designed to include robust and highly adaptive heterotrophic natural soil bacteria and have the capability to convert difficult mixed waste to low molecular weight soluble compounds in order to increase the readily biodegrable soluble organic material. Contact time increases the effectiveness of the pre-treatment waste. During low flow periods, any stagnant water will continue to go through organic reductions. Increasing the readily biodegrable soluble organic material continues through the piping systems, improving the capacity and/or ability to further reduce organic loads. Additional benefits of the system include establishing beneficial biofilms within the structure's piping, thereby providing piping protection and surface area for wastewater treatment. Continual repopulating the bacteria is done in order to out-compete the non-beneficial fecal sulfate reducing bacteria (SRB's), and reducing solution sulfide in the treatment process, thereby reducing the release of corrosive hydrogen sulfide and mitigating the collection system infrastructure corrosion. Finally, incorporating the bacteria into the structure's piping system in effect diverts, at least partially, the wastewater treatment costs to the individual structures as part of the structure's maintenance. The maintenance of the sewer line system, therefore, would be shifted to the structures rather than the city. By moving the servicing from the street to the building, common field servicing problems associated with serving the city's sewer systems, such as blocking traffic or adverse weather related service issues in collection systems, is minimized.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of treating wastewater generated within a structure containing a high concentration of individuals therein prior to the internally generated wastewater entering into an externally located wastewater treatment system comprising the steps of:
identifying at least one structure containing a large population of individuals therein, said structure having at least one wastewater flow channel feeding wastewater generated within said structure to an external wastewater treatment site or associated delivery structures;
determining if said structure is eligible as a high population concentration structure for treating wastewater generated therein prior to placing said wastewater into said external wastewater treatment site or associated delivery structures; and
exposing said at least one wastewater flow channel to a solution which forms a wastewater pretreatment prior to placing said structure's wastewater into said external wastewater treatment site or associated delivery structures;
whereby pre-treating said wastewater generated within said structure reduces wastewater loads being delivered to said wastewater treatment site.

2. The method of treating wastewater generated within a structure containing a high concentration of individuals therein prior to the internally generated wastewater entering into an externally located wastewater treatment system according to claim 1 wherein said pretreatment includes the step of exposing said at least one wastewater flow channel to a bacterial population, said bacterial population including one or more species and/or subspecies of bacteria.

3. The method of treating wastewater generated within a structure containing a high concentration of individuals therein prior to the internally generated wastewater entering into an externally located wastewater treatment system according to claim 2 wherein said bacteria includes one or more facultative bacteria species.

4. The method of treating wastewater generated within a structure containing a high concentration of individuals therein prior to the internally generated wastewater entering into an externally located wastewater treatment system according to claim 1 wherein said step of exposing said at least one wastewater flow channel to said bacterial population includes seeding said at least one wastewater flow channel with a bacterial formulation having a predetermined number and concretion of species and/or subspecies.

5. The method of treating wastewater generated within a structure containing a high concentration of individuals therein prior to the internally generated wastewater entering into an externally located wastewater treatment system according to claim 2 including the step of providing a biological dispensing unit to dispense a bacterial population to said wastewater prior to the structure's wastewater entering said main wastewater treatment system.

6. The method of treating wastewater generated within a structure containing a high concentration of individuals therein prior to the internally generated wastewater entering into an externally located wastewater treatment system according to claim 1 further including the step of monitoring the structure's wastewater prior to delivering said wastewater to the wastewater system.

7. The method of treating wastewater generated within a structure containing a high concentration of individuals therein prior to the internally generated wastewater entering into an externally located wastewater treatment system according to claim 1 wherein said structure is a commercial building, residential building, or combinations thereof.

8. The method of treating wastewater generated within a structure containing a high concentration of individuals therein prior to the internally generated wastewater entering into an externally located wastewater treatment system according to claim 2 further including the step of adjusting the amount of bacterial populations dispensed into the system based upon monitoring.

9. The method of treating wastewater generated within a structure containing a high concentration of individuals therein prior to the internally generated wastewater entering into an externally located wastewater treatment system according to claim 1 further comprising the steps of:
monitoring the wastewater exiting said structure;
analyzing said wastewater exiting said structure for one or more components, characteristics, or combinations thereof relating to said wastewater; and
adjusting said exposure of at least one wastewater flow channel to said wastewater pretreatment based upon said analysis.

10. The method of treating wastewater generated within a structure containing a high concentration of individuals therein prior to the internally generated wastewater entering into an externally located wastewater treatment system according to claim 9 further including the steps of:
providing at least one sensor adapted to detect one or more components, characteristics, or combinations thereof of said exiting wastewater;
providing a biological dispensing unit at or near at least one wastewater flow channel;
electrically coupling said sensor to said biological dispensing unit; and
dispensing said biological population from said biological dispensing unit based on the results of the analysis of said exiting wastewater.

11. The method of treating wastewater generated within a structure containing a high concentration of individuals therein prior to the internally generated wastewater entering into an externally located wastewater treatment system according to claim 2 further including the step of correlating said exposure of said bacterial populations to water usage periods, wastewater production periods, or combinations thereof.

12. The method of treating wastewater generated within a structure containing a high concentration of individuals therein prior to the internally generated wastewater entering into an externally located wastewater treatment system according to claim 11 wherein the amount of said bacterial population delivered is adjusted based upon said water usage periods, said wastewater production periods, or combinations thereof.

13. The method of treating wastewater generated within a structure containing a high concentration of individuals therein prior to the internally generated wastewater entering into an externally located wastewater treatment system according to claim 11 wherein said use periods is based on time periods of high water usage, high wastewater generation, low water usage, low wastewater generation, or combinations thereof based on daily, weekly, monthly, or seasonal usage.

14. The method of treating wastewater generated within a structure containing a high concentration of individuals therein prior to the internally generated wastewater entering into an externally located wastewater treatment system according to claim 2 wherein said exposure of said bacterial populations is based on the type of wastewater generated.

15. The method of treating wastewater generated within a structure containing a high concentration of individuals therein prior to the internally generated wastewater entering into an externally located wastewater treatment system according to claim 2 further including the step of adjusting the amount of said bacterial population exposed to said wastewater is based on the amount of one or more types of wastewater generated.

16. The method of treating wastewater generated within a structure containing a high concentration of individuals therein prior to the internally generated wastewater entering into an externally located wastewater treatment system according to claim 2 wherein said microbial population is continuously supplied to the structure's wastewater system.

17. The method of treating wastewater generated within a structure containing a high concentration of individuals therein prior to the internally generated wastewater entering into an externally located wastewater treatment system according to claim 1 further including the step of forming a biological environment within at least one wastewater flow channel, said biological environment in the form of at least a biofilm formed from one or more bacteria adapted to reduce wastewater loads prior to delivery of said structure wastewater to said wastewater treatment site.

18. The method of treating wastewater generated within a structure containing a high concentration of individuals therein prior to the internally generated wastewater entering into an externally located wastewater treatment system according to claim 2 further including the step of releasing said pretreated wastewater generated from said structure and having on or more predetermined bacteria species and/or subspecies into said external wastewater site or associated delivery structures, whereby said pretreated wastewater released improves one or more processes of said external wastewater site.

19. The method of treating wastewater generated within a structure containing a high concentration of individuals therein prior to the internally generated wastewater entering into an externally located wastewater treatment system according to claim 1 wherein all wastewater flows channel within said structure are exposed to a solution which forms a wastewater pretreatment.

20. A method of reducing the loading of a primary wastewater treatment site system by treating wastewater generated from a predetermined area having one or more highly populated structures within said area prior to entry into a wastewater treatment site or its associated wastewater system delivery structures comprising the steps of:
identifying an area having a predetermined number of structures having a concentration of occupants therein,
identifying each structure from said area having a predetermined number of structures having a concentration of occupants therein which is fluidly connected to a municipal wastewater treatment system;
identifying within each said structure an access to at least one wastewater flow channel fluidly connected to said municipal wastewater treatment system;
distributing to said at least one wastewater flow channel from each said structure a bacterial population, said bacterial population at a concentration sufficient to establish a population of bacteria within at least one wastewater flow channel of each structure, within said wastewater generated within each said structure and released to said municipal wastewater treatment system, or combinations thereof, thereby forming a pretreatment; and
exposing said wastewater generated from each said structure to said pretreatment prior to placing each said structure's wastewater into said municipal wastewater treatment system;
whereby distribution of said bacteria population to said at least one flow channel from each said structure reduces wastewater loads prior to entry into said municipal wastewater treatment system.
